(19) United States
(12) Patent Application Publication
(10) Pub. No.: US 2008/0018655 A1
(43) Pub. Date: Jan. 24, 2008

(54) Organic light emitting display

(75) Inventors: Min Koo Han, Seoul (KR); Hyun Sang Park, Seongnam-si (KR); Jae Hoon Lee, Seoul (KR)

Correspondence Address: IPHORGAN, LTD., 1130 LAKE COOK ROAD, SUITE 240, BUFFALO GROVE, IL, 60089, US

(73) Assignee: Seoul National University Industry

(21) Appl. No.: 11/825,769

(22) Filed: Jul. 9, 2007

(30) Foreign Application Priority Data
Jul. 20, 2006 (KR) 10-2006-0067928

(51) Int. Cl. G09G 5/36

(52) U.S. Cl. 345/545

(57) ABSTRACT

The present invention relates to an organic light emitting display, and an aspect of the invention is to minimize the phenomenon of reduction in luminance of the organic light emitting diode display, by dividing an analog data to a positive data and a negative data, applying the same data with different polarities to the control electrode of a driving transistor, and preventing the deterioration of threshold voltage of the driving transistor.

For this purpose, the present invention discloses an organic light emitting display including a frame memory that stores data of one or more frames, doubles the frequency of the frame data, and repeatedly outputs the frame data; a look-up table memory that divides the frame data doubled and outputted from the frame memory, into two digital input signals such as a positive data and a negative data, and outputs the data; and a digital-analog converter that receives the positive data and negative data outputted from the look-up table memory, converts the data to analog data, and outputs the analog data.

### CROSS-REFERENCE TO RELATED APPLICATIONS

This application claims priority to and the benefit of Korean Patent Application No. 10-2006-067928, filed on Jul. 20, 2006 and, the entire content of which are incorporated herein by reference.

### BACKGROUND OF THE INVENTION

1. Field of the Invention

The present invention relates to an organic light emitting display, and more particularly, to an organic light emitting display which can minimize the phenomenon of reduced luminance due to deterioration of the threshold voltage in a driving transistor, by dividing analog data to positive data and negative data, and applying the data to the driving transistor.

2. Description of the Related Art

Organic light emitting displays of the related art are display devices which emit light by electrically exciting a fluorescent or phosphorescent organic compound, and images are manifested by driving (N×M) entities of organic light emitting cells. Such an organic light emitting cell is constituted of an anode, an organic thin film and a cathode. The organic thin film consists of a multilayer structure including an emitting layer (EML), an electron transport layer (ETL) and a hole transport layer (HTL), so as to achieve good balance between electrons and holes and thus to improve the luminous efficiency, and may further include a separate electron injecting layer (EIL) and a separate hole injecting layer (HIL).

As the method of driving an organic light emitting cell thus formed, there may be mentioned a passive matrix method and an active matrix method using a thin film transistor (TFT) or a MOSFET. The passive matrix method involves driving the cell by forming an anode and a cathode to be perpendicular to each other, and selecting a line, while the active matrix method involves driving the cell by coupling a transistor and a capacitor to each of pixel electrodes, and maintaining the voltage by means of the capacity of the capacitor.

The driving transistor used in pixel circuits of such organic light emitting display of the active matrix method is supposed to continuously supply a driving current while the organic light emitting diodes emit light, and at this time, when data of the same polarity are continuously applied to the control electrode of the driving transistor, the threshold voltage (V_{TH}) of the driving transistor can be shifted.

Such change in the threshold voltage of the driving transistor results in a different driving current to flow through the organic light emitting diode in each of the pixel circuits in accordance with the degree of change in the threshold voltage even though the same data are applied. As a result, there rises an occurrence of deterioration of image quality and reduction of luminance in the organic light emitting display.

### SUMMARY OF THE INVENTION

The present invention is intended to overcome the above-described problems of the related art, and it is an aspect of the present invention to provide an organic light emitting display in which the overall luminance uniformity of the organic light emitting display can be improved by dividing a frame into a first period and a second period, applying an analog data of positive level to the control electrode of the driving transistor for the first period to render the organic light emitting diode to emit light, while applying for the second period an analog data of negative level, which is opposite to the analog data applied to the control electrode of the driving transistor at the first period, thus to turn off the organic light emitting diode and simultaneously to restore the threshold voltage of the driving transistor from deteriorating.

Furthermore, it is another aspect of the invention to provide an organic light emitting display which can be prevented from a phenomenon of motion blur and can achieve a high contrast ratio, by variously adjusting the ratio between the light emission driving period and the threshold voltage deterioration preventing period in an image display period for a frame to 1:1 or some other ratio, thus to allow a first image to be displayed naturally between one frame and the next frame.

It is another aspect of the invention to provide an organic light emitting display which is applicable to various pixel circuits, in addition to the exemplary pixel circuit described in the present invention, and in this case, which does not require additional wiring or element in the pixel, and which can enhance the reliability by adding only minimal external circuits such as frame memory and the like.

To achieve the above-described aspects, the organic light emitting display according to the present invention includes a frame memory which stores data for at least one frame and doubles the frequency to repeatedly output the frame data; a look-up table memory which divides the frame data that is doubled and outputted from the frame memory, into two digital input signals to be outputted, such as a positive data and a negative data; and a digital-analog converter which receives the positive data and negative data outputted from the look-up table memory, and converts the data to an analog data.

The frame memory is electrically coupled to the look-up table memory, and may store a received subsequent frame data, double the frequency of a previously stored frame data, divide the frame data, and transmit the divided data to the look-up table memory.

The look-up table memory is electrically coupled between the frame memory and the digital-analog converter, and may divide the doubled frame data into a positive data and a negative data for outputting an analog data of positive level and an analog data of negative level, and then convert and alternately output the data.

The digital-analog converter is electrically coupled to the look-up table memory, and may convert the digital input data received from the look-up table memory to a positive analog signal and a negative analog signal, and output the signals.

The digital-analog converter can output the analog data of positive level and the analog data of negative level, which correspond to the positive data and negative data received from the look-up table memory, respectively, in an alternating manner through the same data line.

The digital-analog converter may be applied with an external control signal which periodically selects between the analog data of positive level and the analog data of negative level so that the analog data can be outputted in an alternating manner.

The organic light emitting display can further include a switching element which is electrically coupled to the digital-analog converter for supplying the analog data, with the control electrode being electrically coupled to scan lines, and which applies the analog data to each pixel when a scan signal for selecting the respective pixel is applied; a driving transistor which has its control electrode electrically coupled to the switching element, and controls the driving current from a first power line; a storage capacitor which is electrically coupled between the control electrode of the driving transistor and a second power line; and an organic light emitting diode which is electrically coupled between the driving transistor and the second power line, and displays an image by means of the driving current applied from the driving transistor.

The switching element is electrically coupled to the digital-analog converter, and can receive the transmitted analog data of positive level and analog data of negative level that are outputted from the digital-analog converter through data lines.

The analog data applied to the switching element can be outputted as analog data of positive level and analog data of negative level, which respectively correspond to the positive data and negative data applied to the digital-analog converter, through the data line in an alternating manner.

The switching element has its control electrode electrically coupled to the scan line, its first electrode electrically coupled to the digital-analog converter, and its second electrode electrically coupled between the first electrode of the storage capacitor and the control electrode of the driving transistor.

The storage capacitor has its first electrode electrically coupled between the first electrode of the switching element and the control electrode of the driving transistor, while having its second electrode electrically coupled between the second electrode of the driving transistor and the anode electrode of the organic light emitting diode, so that a voltage difference can be stored between the first electrode and the second electrode.

The storage capacitor has its first electrode electrically coupled between the first electrode of the switching element and the control electrode of the driving transistor, and its second electrode electrically coupled between the second electrode of the driving transistor and the second power line, so that a voltage difference can be stored between the first electrode and the second electrode.

The driving transistor has its control electrode electrically coupled between the first electrode of the storage capacitor and the second electrode of the switching element, and its first electrode electrically coupled to the first power line, and its second electrode electrically coupled to the anode electrode of the organic light emitting diode.

As such, the organic light emitting display according to the present invention can have enhanced luminance uniformity over the entire organic light emitting display, by dividing a frame into a first period and a second period, and applying an analog data of positive level to the control electrode of the driving transistor for the first period so as to allow the organic light emitting diode to emit light, while applying, for the second period, an analog data of negative level, which is opposite to the analog data applied to the control electrode of the driving transistor for the first period, so as to turn off the organic light emitting diode and simultaneously to restore the deteriorated threshold of the driving transistor.

Furthermore, an organic light emitting display is provided which can be prevented from the phenomenon of motion blur and can realize a high contrast ratio, by variously adjusting the ratio between the light emission driving period and the threshold voltage deterioration preventing period in an image display period for a frame to 1:1 or some other ratio, thus to allow a first image to be displayed naturally between one frame and the next frame.

An organic light emitting display is also provided which is applicable to various pixel circuits, in addition to the exemplary pixel circuit described in the invention, and at this time, does not require any additional wiring or element within the pixel, and can have increased reliability by adding only minimal external circuits such as frame memory and the like.

### BRIEF DESCRIPTION OF THE DRAWINGS

The above and other aspects, features and advantages of the present invention will be more apparent from the following detailed description taken in conjunction with the accompanying drawings, in which:

FIG. 1 is a block diagram illustrating an organic light emitting display according to the present invention.

FIG. 2 is a block diagram illustrating the configuration of the data driver of an organic light emitting display according to an embodiment of the present invention.

FIG. 3 is a timing diagram of the data driver shown in FIG. 2.

FIG. 4 is a circuit diagram illustrating an exemplary pixel circuit to which the data signal outputted from the data driver shown in FIG. 2 is applied.

FIG. 5 is a timing diagram of the pixel circuit shown in FIG. 4.

FIG. 6 is a circuit diagram illustrating another exemplary pixel circuit to which the data signal outputted from the data driver shown in FIG. 2 is applied.

FIG. 7 is a timing diagram of the pixel circuit shown in FIG. 6.

### DETAILED DESCRIPTION OF THE PREFERRED EMBODIMENTS

Hereinafter, exemplary embodiments of the present invention will be described in detail with reference to the attached drawings, to an extent that a person having an ordinary skill in the art pertained to the present invention can easily carry out the present invention.

Here, the same reference numeral was assigned for parts having similar configuration and operation throughout the specification. Furthermore, if a part is said to be electrically coupled to another part, the expression includes the case where the part is directly coupled, as well as the case where the part is coupled to another part with a different element disposed between the parts.

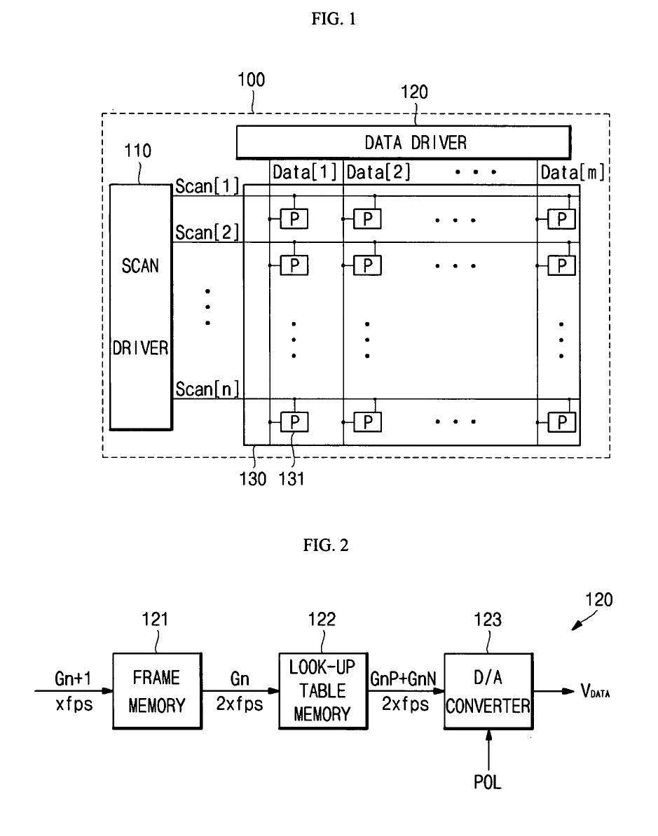

FIG. 1 shows a block diagram illustrating the configuration of an organic light emitting display according to the present invention.

Referring to FIG. 1, the organic light emitting display 100 can include a scan driver 110, a data driver 120 and an organic light emitting display panel (hereinafter, referred to as panel 130).

The scan driver 110 can supply scan signals to the panel 130 in sequence through scan lines (Scan[1], Scan[2], . . . , Scan[n]).

The data driver 120 can supply data signals (analog data) to the panel 130 through data lines (Data[1], Data[2], . . . , Data[m]).

The panel 130 can include a plurality of scan lines (Scan[1], Scan[2], . . . , Scan[n]) which are aligned in the horizontal direction, a plurality of data lines (Data[1], Data[2], . . . , Data[m]) which are aligned in the vertical direction, and pixel circuits 131 defined by the plurality of scan lines (Scan[1], Scan[2], . . . , Scan[n]) and the plurality of data lines (Data[1], Data[2], . . . , Data[m]).

Here, the pixel circuit can be formed in a pixel region which is defined by two adjacent scan lines and two adjacent data lines. Of course, the scan lines (Scan[1], Scan[2], . . . , Scan[n]) are supplied with scan signals from the scan driver 110, and the data lines (Data[1], Data[2], . . . , Data[m]) are supplied with data signals (analog data) from the data driver 120, as described above. The panel 130 is supplied with a first power (VDD) and a second power (VSS) from an external source, and supplies them to each of the pixel circuits 131. The pixel circuits 131 supplied with the first power (VDD) and the second power (VSS) display an image on the panel in accordance with the respective data voltage.

FIG. 2 shows a block diagram illustrating the configuration of an organic light emitting display according to an embodiment of the present invention. The term ‘data driver’ that will be described in the following refers in all cases to the data driver 120 in the organic light emitting display 100 disclosed in FIG. 1.

Referring to FIG. 2, the data driver 120 in the organic light emitting display includes a frame memory 121, a look-up table memory 122 and a digital-analog converter 123.

First, the frame memory 121 doubles the frequency of the frame data (Gₙ) having a predetermined bit number that is stored in the frame memory 121, and repeatedly outputs the frame data. At the same time, the frame memory 121 stores the frame data (Gₙ₊₁) of a subsequent frame that has been applied from an external source.

The frame data (Gn xfps) applied to the frame memory 121 is transmitted to the frame memory at a frame rate of x fps (frames per second), i.e., transmitting x frames (30 to 60 on average) per second. The transmitted frame data (Gn xfps) is stored in the frame memory 121 for a single frame memory period. At this time, the frame memory doubles the frequency of the frame data, and repeatedly outputs the frame data (Gn xfps) applied to the frame memory two times into the previous frame (Gn 2xfps) at a transmission rate of 2xfps.

Next, the look-up table memory 122 divides the frame data and outputs into a positive data (GnP) and a negative data (GnN), which are two digital data corresponding to the same two frame data sets (Gn 2xfps) applied from the frame memory 121. Here, the positive data (GnP) and the negative data (GnN) respectively become the input signals for outputting an analog data of positive level and an analog data of negative level that are applied to each pixels.

Subsequently, the digital-analog converter 123 converts the positive data (GnP) and the negative data (GnN), which are digital signals applied from the look-up table memory 122, to analog data (V_{DATA}), which is an analog signal applied to the pixels, and outputs the data. Here, the analog data (V_{DATA}) has a positive level (V_{DATA}P) and a negative level (V_{DATA}N) which correspond to the positive data (GnP) and negative data (GnN), and an external control signal (POL) is applied to the analog data (V_{DATA}) so that the analog data (V_{DATA}) outputs the positive level (V_{DATA}P) and the negative level (V_{DATA}N) in an alternating manner. At this time, the analog data of the positive level (V_{DATA}P) and the negative level (V_{DATA}N) should be appropriately selected to be in a mutually corresponding relationship in terms of the size of applied voltage, time and the like, depending on the deterioration characteristics of the pixel, and such relationship can be obtained through the conversion relationship used in the look-up table memory or the digital-analog converter.

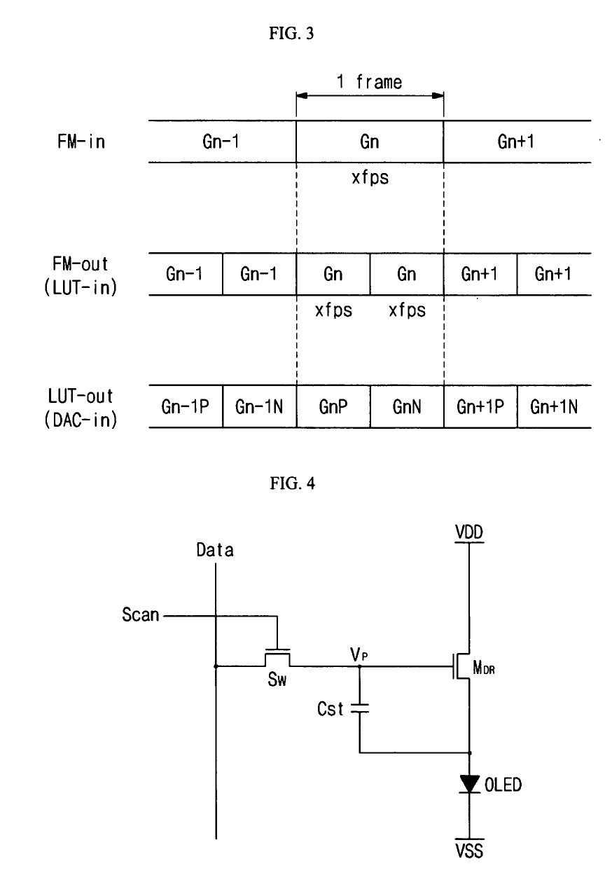

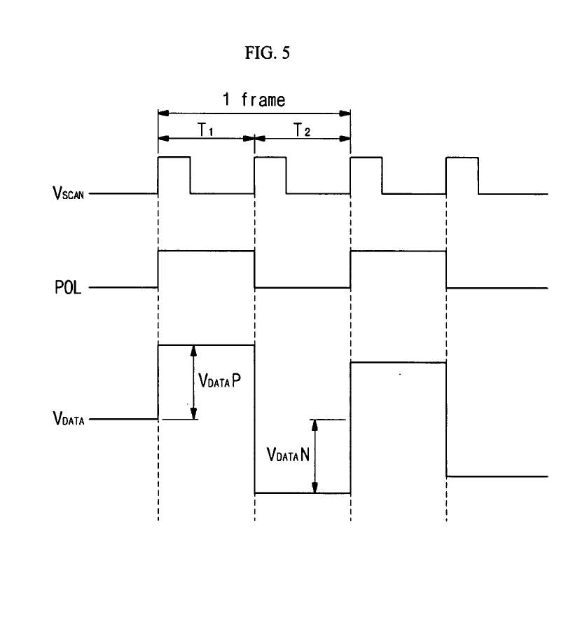

FIG. 3 illustrates a timing diagram of the data driver shown in FIG. 2. As shown in FIG. 3, the timing diagram of the data driver illustrates only the digital signal parts excluding the output signals from the digital-analog converter 123, since the output signals from the digital-analog converter 123 are analog signals. The analog data outputted from the digital-analog converter shown in FIG. 2 will be described with reference to the pixel circuits shown in FIG. 4 and FIG. 5. The timing diagram of the data driver as shown in FIG. 3 includes the input waveform and the output waveform for the frame memory 121 of the data driver in FIG. 2, look-up table memory 122 and digital-analog converter 123.

The input waveform (FM_in) for the frame memory 121 is an image signal, and x (30 to 60 on average) frame image signals per second are transmitted, while one frame image signal, that is, the frame data (Gn) is stored in the frame memory 121 for a single frame memory period (1/x). At this time, the frame memory doubles the frequency of the frame data (Gn), and outputs two frame data sets (Gn+Gn) that are the same as the frame data (Gn xfps) applied to the frame memory, into the previous frame at a transmission rate of 2xfps in an output waveform (FM_out). Here, the input waveform (FM_in) and the output waveform (FM_out) of the frame memory 121 are digital signals having the same amplitude, but the time for frame data supplying differs in accordance to the image to be displayed. In FIG. 3, the input waveform (FM_in) and the output waveform (FM_in) of the frame memory 121 are indicated as blocks, but these waveforms may be waveforms with different timing for the supplying of signals applied from an external source. The input waveform (LUT_in) of the look-up table memory 122 is identical to the output waveform (FM_out) of the frame memory 121 because the output waveform of the frame memory 121 is applied thereto, while the output waveform (LUT_out) is divided into two digital data sets of the positive data (GnP) and the negative data (GnN) corresponding to two identical frame data sets (Gn 2xfps), and outputted. Here, the positive data (GnP) and the negative data (GnN) respectively become the input signals for outputting the analog data of positive level and the analog data of negative level that are applied to the pixels.

The positive data (GnP) and the negative data (GnN) shown in FIG. 3 are illustrated as if the negative data (GnN) is outputted after the outputting of the positive data (GnP) during one frame. However, it does not matter even if the positive data (GnP) is outputted after the outputting of the negative data (GnN), and the present invention is not limited by the output order of the positive data (GnP) and the negative data (GnN).

The input waveform (DAC_in) of the digital-analog converter 123 is identical to the output waveform (LUT_out) of the look-up table memory 122 since the output waveform of the look-up table memory 122 is applied thereto, and the output waveform (V_{DATA}), which is an analog data, will be described with reference to FIG. 4 and FIG. 5.

FIG. 4 shows a circuit diagram illustrating an exemplary pixel circuit to which the data signal outputted from the data driver shown in FIG. 2 is applied. The pixel circuit that will be described in the following refers in all cases to one of the pixel circuits in the organic light emitting display 100 shown in FIG. 1. Furthermore, although the switching element and driving transistor shown in FIG. 4 are illustrated as N-type transistors, they may include other switching element or transistor having the same or similar functions.

Referring to FIG. 4, the pixel circuit to which the data signal outputted from the data driver shown in FIG. 2 is applied includes a scan line (Scan), a data line (DATA), a first power line (VDD), a second power line (VDD), a switching element (Sw), a storage capacitor (Cst), a driving transistor (M_{DR}) and an organic light emitting diode (OLED).

The scan line (Scan) plays a role of supplying a scan signal for selecting organic light emitting diodes (OLED) to emit light, to the control electrode of the switching element (Sw). Of course, such scan line (Scan) can be electrically coupled to the scan driver 110 (see FIG. 1) which generates scan signals.

The data line (Data) plays a role of supplying an analog data (V_{DATA}) which is proportional to the luminance, to the first electrode of the storage capacitor (Cst) and the control electrode of the driving transistor (M_{DR}). Of course, such data line (Data) can be electrically coupled to the data driver 120 (see FIG. 1) which generates a data voltage. An external control signal (POL) is applied to the analog data (V_{DATA}), and the analog data is applied to the data line (Data) in an alternating manner between the positive level (V_{DATA}P) and the negative level (V_{DATA}N). Here, the analog data of the positive level (V_{DATA}P) and the negative level (V_{DATA}N) should be appropriately selected to be in a mutually corresponding relationship in terms of the size of applied voltage, time and the like, depending on the deterioration characteristics of the pixel, and such relationship can be obtained through the conversion relationship used in the look-up table memory or the digital-analog converter.

The first power line (VDD) allows a first power to be supplied to the organic light emitting diode (OLED). The second power line (VSS) allows a second power to be supplied to the organic light emitting diode (OLED). The switching element (Sw) is configured such that its first electrode (drain electrode or source electrode) is electrically coupled to the data line (Data), its second electrode (source electrode or drain electrode) is electrically coupled between the first electrode of the storage capacitor (Cst) and the control electrode of the driving transistor (M_{DR}), and its control electrode is electrically coupled to the scan line (Scan). The switching element (Sw) is turned on when a scan signal of high level is applied thereto, and then applies an analog data (V_{DATA}) to the first electrode of the storage capacitor (Cst) and the control electrode of the driving transistor (M_{DR}). The switching element is turned off when a scan signal of low level is applied thereto, and intercepts the transmission of the analog data (V_{DATA}) to the first electrode of the storage capacitor (Cst) and the control electrode of the driving transistor (M_{DR}). The storage capacitor (Cst) has its first electrode electrically coupled between the second electrode of the switching element and the control electrode of the driving transistor (M_{DR}), and its second electrode electrically coupled between the second electrode of the driving transistor (M_{DR}) and the anode electrode of the organic light emitting diode (OLED). The storage capacitor (Cst) stores the potential difference between the first electrode and the second electrode.

The driving transistor (M_{DR}) has its first electrode electrically coupled to the first power line (VDD), its second electrode electrically coupled to the anode of the organic light emitting diode (OLED), and its control electrode electrically coupled to the second electrode of the switching element (Sw). Such driving transistor (M_{DR}) plays a role of supplying a certain amount of current from the first power line (VDD) to the organic light emitting diode (OLED). Of course, since analog data (V_{DATA}) is supplied to the first electrode of the storage capacitor (Cst) and charges the storage capacitor, even if the switching element (Sw) is turned off, the voltage stored in the storage capacitor (Cst) allows analog data (V_{DATA}) to be continuously applied to the control electrode of the driving transistor (M_{DR}) for a certain time period.

Here, the driving transistor (M_{DR}) may be any one selected from an amorphous silicon thin film transistor, a polysilicon thin film transistor, an organic thin film transistor, a nano-sized thin film semiconductor transistor and equivalents thereof, but the material or type of the driving transistor is not limited thereto. In particular, in the case of a driving transistor (M_{DR}) formed of amorphous thin film silicon, deterioration of the threshold voltage of the driving transistor (M_{DR}) takes place rapidly over time, and use of the data driver of the present invention is advantageous in restoring from deterioration.

It is noted that the method of laser crystallization is a method of crystallizing amorphous silicon by irradiating an excimer laser to the silicon, while the method of metal-induced crystallization is a method of crystallizing amorphous silicon by, for example, placing a metal on the amorphous silicon and applying a predetermined temperature to the silicon to initiate crystallization from the metal. The method of high pressure crystallization is a method of crystallizing amorphous silicon by, for example, applying a predetermined pressure to the silicon.

In addition, when the driving transistor (M_{DR}) is produced by the method of metal-induced crystallization, the driving transistor (M_{DR}) may further include any one selected from nickel (Ni), cadmium (Cd), cobalt (Co), titanium (Ti), palladium (Pd), tungsten (W) and equivalents thereof.

The organic light emitting diode (OLED) has its anode electrically coupled to the second electrode of the driving transistor (M_{DR}) and its cathode electrically coupled to the second power line (VSS). Such organic light emitting diode (OLED) plays a role of emitting light at a predetermined brightness by means of the current controlled by the driving transistor (M_{DR}).

Here, the organic light emitting diode (OLED) includes a light emitting layer (EML), and this light emitting layer (EML) may be formed of any one selected from fluorescent materials, phosphorescent materials, mixtures thereof and equivalents thereof. However, the material or type of the light emitting layer (EML) is not limited thereto. Also, the light emitting layer (EML) may be formed of any one selected from red light emitting materials, green light emitting materials, blue light emitting materials, mixtures thereof and equivalents thereof, but again, the material or type is not limited thereto.

FIG. 5 shows a timing diagram of the pixel circuit shown in FIG. 4.

As shown in FIG. 5, the driving timing diagram of the pixel circuit can have one frame divided into a first period and a second period. More specifically, one frame consists of a light emission driving period (T₁) and a threshold voltage deterioration preventing period (T₂). Preferably, the light emission driving period (T₁) and the threshold voltage deterioration preventing period (T₂) may be at a ratio of 1:1, but the present invention is not limited to this ratio.

The light emission driving period (T₁) is a period during which an analog data (V_{DATA}) of positive level (V_{DATA}P) is applied to the control electrode of the driving transistor (M_{DR}) to make the organic light emitting diode (OLED) to emit light at a predetermined brightness, while the threshold voltage deterioration preventing period (T₂) is a period during which an analog data (V_{DATA}) of negative level (V_{DATA}N), which is opposite in polarity to the analog data (V_{DATA}) of positive level (V_{DATA}P), is applied to the control electrode of the driving transistor (M_{DR}) to prevent the deterioration of threshold voltage of the driving transistor (M_{DR}). In other words, analog data sets of positive level (V_{DATA}P) and negative level (V_{DATA}N) are outputted in an alternating manner to the control electrode of the driving transistor (M_{DR}).

According to the present invention, since analog data of negative level (V_{DATA}N), which has a one-to-one correspondence with the analog data of positive level (V_{DATA}P) used during light emission, and has a different polarity, is supplied to the control electrode of the driving transistor (M_{DR}), an analog data of negative level (V_{DATA}N) corresponding to the degree of deterioration of the control electrode of the driving transistor (M_{DR}) due to the analog data of positive level (V_{DATA}P), will be applied to the electrode. For example, if the analog data of positive level (V_{DATA}P) is small, a small analog data of negative level (V_{DATA}N) will be applied to the control electrode of the driving transistor (M_{DR}), whereas if the analog data of positive level (V_{DATA}P) is large, a large analog data of negative level (V_{DATA}N) will be applied to the control electrode of the driving transistor (M_{DR}). Therefore, the present invention can prevent the phenomenon of luminance non-uniformity over the entire panel, by applying an analog data of negative level proportionally to the analog data of positive level (V_{DATA}P) that is supplied to each pixel circuit, and thus restoring the deterioration of threshold voltage of the driving transistor (M_{DR}) generated when an analog data of the same polarity is applied to the driving transistor (M_{DR}) for a long time.

Furthermore, as described above, the present invention includes a light emission driving period (T₁) and a threshold voltage deterioration preventing period (T₂) within one frame. For example, when the ratio between the light emission driving period (T₁) and the threshold voltage deterioration preventing period (T₂) is set to 1:1, an analog data should be applied at a rate of 120 frames per second in order to realize an image of 60 frames per second, and the same analog data differing only in polarity should be applied once again to each pixel, once for the light emission period and once for the threshold voltage deterioration preventing period. Therefore, there exists a threshold voltage deterioration preventing period between one light emission driving period and the subsequent light emission driving period of the pixel, and during this period, light emission does not occur, and a first image (for example, a black image) is displayed between a frame and another frame. Thus, the phenomenon of motion blur is naturally eliminated, and a high contrast ratio can be obtained.

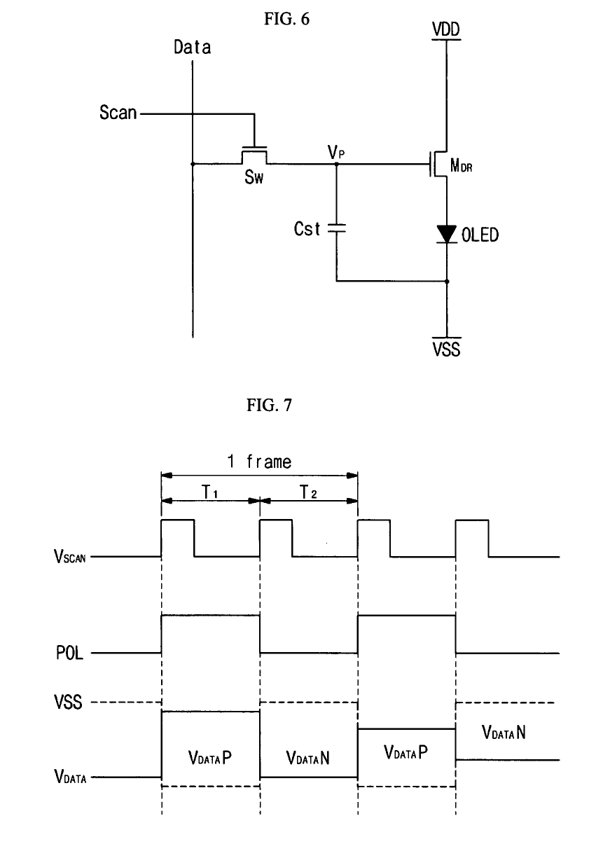

FIG. 6 shows a circuit diagram illustrating another exemplary pixel circuit to which the data signal outputted from the data driver shown in FIG. 2 is applied.

As shown in FIG. 6, the other exemplary pixel circuit to which the data signal outputted from the data driver shown in FIG. 2 is applied, has the same structure as the pixel circuit shown in FIG. 4, except for the coupling configuration to the storage capacitor. To explain the part different from that in FIG. 4, the storage capacitor (Cst) has its first electrode electrically coupled between the control electrode of the driving transistor (M_{DR}) and the second electrode of the switching element (Sw), and its second electrode electrically coupled between the cathode electrode of the organic light emitting diode (OLED) and the second power line (VSS). The storage capacitor (Cst) stores the potential difference between the analog data applied to the first electrode and the second power at the second electrode. At this time, if the amplitude of the second power is adjusted to be opposite to the analog data, the amplitude of the analog data can be reduced.

FIG. 7 shows a timing diagram of the pixel circuit shown in FIG. 6. As shown in FIG. 7, the timing diagram of the pixel circuit of FIG. 6 illustrates that the second power applied from the second power line (VSS) is applied in a periodically alternating manner between a negative level and a positive level, and when the positive level (V_{DATA}P) and the negative level (V_{DATA}N) of the analog data (V_{DATA}) are applied, the difference in the amplitude is reduced. At this time, the amplitude between the second power and the analog data includes the positive level (V_{DATA}P) and the negative level (V_{DATA}N), while the amplitude of the positive level (V_{DATA}P) and the negative level (V_{DATA}N) is identical to the amplitude of the positive level (V_{DATA}P) and the negative level (V_{DATA}N) of the analog data in the timing diagram shown in FIG. 5.

That is, when an analog data of positive level (V_{DATA}P) is applied, the second power is adjusted to be maintained at a low level, and when an analog data of negative level (V_{DATA}N) is applied, the second power is adjusted to be maintained at a high level. Here, the analog data of positive level (V_{DATA}P) and the second power, and the analog data of negative level (V_{DATA}N) and the second power are adjusted to have the same values as the analog data of positive level (V_{DATA}P) and negative level (V_{DATA}N) shown in FIG. 5. Therefore, the positive level (V_{DATA}P) and the negative level (V_{DATA}N) can have a potential of the same polarity, and thus, an effect of reducing the output amplitude that is applied to the data line can be obtained.

As discussed above, the organic light emitting display according to the present invention allows an improvement in the overall luminance uniformity of the light emitting diodes display device, by dividing one frame into a first period and a second period, applying an analog data of positive level to the control electrode of the driving transistor for the first period to allow the organic light emitting diode to emit light, and applying, for the second period, an analog data of negative level, which is opposite to the analog data applied to the control electrode of the driving transistor for the first period, thus to turn off the organic light emitting diode and simultaneously restoring the threshold voltage of the driving transistor from deterioration.

As such, the organic light emitting display according to the present invention can prevent the phenomenon of motion blur and realize a high contrast ratio, by variously adjusting the ratio between the light emission driving period and the threshold voltage deterioration preventing period during the image display period for one frame, to 1:1 or some other ratio, and allowing a first image to be displayed naturally between one frame and the subsequent frame.

Also, as such, the organic light emitting display according to the present invention is applicable to various pixel circuits in addition to the exemplary pixel circuit disclosed in the present invention, and at this time, does not require any additional wiring or element in the pixel, and can have increased reliability by adding only minimal external circuits such as frame memory and the like.

The above description is merely one embodiment for achieving the organic light emitting display according to the present invention. The present invention is not limited to the embodiment described above, and it will be apparent to those having ordinary skill in the art that various modifications and alterations may be made without deviating from the scope and technical spirit of the present invention as defined by the attached claims.

What is claimed is:

1. An organic light emitting display comprising:
a frame memory which stores data for one or more frames, doubles the frequency, and repeatedly outputs the frame data;
a look-up table memory which divides the frame data that has been doubled and outputted from the frame memory, to two digital input signals such as positive data and negative data, and outputs the data; and
a digital-analog converter which receives the positive data and the negative data outputted from the look-up table memory, and converts the data to an analog data for outputting.

2. The organic light emitting display of claim 1, wherein the frame memory is electrically coupled to the look-up table memory, stores a subsequent frame data applied, doubles the frequency of the stored frame data to divide the frame data, and transmits the frame data to the look-up table memory.

3. The organic light emitting display of claim 1, wherein the look-up table memory is electrically coupled between the frame memory and the digital-analog converter, divides the doubled frame data into a positive data and a negative data for outputting an analog data of positive level and analog data of negative level, and outputs the divided data in an alternating manner.

4. The organic light emitting display of claim 1, wherein the digital-analog converter is electrically coupled to the look-up table memory, converts the positive data and negative data applied from the look-up table memory to a corresponding analog data of positive level and a corresponding analog data of negative level, respectively, and outputs the analog data.

5. The organic light emitting display of claim 1, wherein the digital-analog converter outputs the analog data of positive level and the analog data of negative level, which correspond to the positive data and negative data applied from the look-up table memory, through the same data line in an alternating manner.

6. The organic light emitting display of claim 1, wherein the digital-analog converter is further applied with an external control signal for selecting the analog data of positive level and the analog data of negative level to be periodically outputted in an alternating manner.

7. The organic light emitting display of claim 1, further comprising:
a switching element which is electrically coupled to the digital-analog converter supplying the analog data, and has its control electrode electrically coupled to the scan line, so as to apply the analog data to each pixel when a scan signal for selecting the pixels is applied;
a driving transistor which has its control electrode electrically coupled to the switching element, and controls the driving current at a first power line;
a storage capacitor which is electrically coupled between the control electrode of the driving transistor and a second power line; and
an organic light emitting diode which is electrically coupled between the driving transistor and the second power line, and displays an image by means of the driving current applied from the driving transistor.

8. The organic light emitting display of claim 7, wherein the switching element is electrically coupled to the digital-analog converter, and receives the transmitted analog data of positive level and the analog data of negative level that are outputted from the digital-analog converter, through a data line.

9. The organic light emitting display of claim 7, wherein the analog data applied to the switching element is outputted as an analog data of positive level and an analog data of negative level which correspond to the positive data and negative data applied to the digital-analog converter, in an alternating manner through a data line.

10. The organic light emitting display of claim 7, wherein the switching element has its control electrode electrically coupled to the scan line, its first electrode electrically coupled to the digital-analog converter, and its second electrode electrically coupled between the first electrode of the storage capacitor and the control electrode of the driving transistor.

11. The organic light emitting display of claim 7, wherein the storage capacitor has its first electrode electrically coupled between the first electrode of the switching element and the control electrode of the driving transistor, and its second electrode electrically coupled between the second electrode of the driving transistor and the anode electrode of the organic light emitting diode, and the storage capacitor stores a voltage difference between the first electrode and the second electrode.

12. The organic light emitting display of claim 7, wherein the storage capacitor has its first electrode electrically coupled between the first electrode of the switching element and the control electrode of the driving transistor, and its second electrode electrically coupled between the second electrode of the driving transistor and the second power line, and the storage capacitor stores a voltage difference between the first electrode and the second electrode.

13. The organic light emitting display of claim 7, wherein the driving transistor has its control electrode electrically coupled between the first electrode of the storage capacitor and the second electrode of the switching element, its first electrode electrically coupled to the first power line, and its second electrode electrically coupled to the anode electrode of the organic light emitting diode.
